(19) United States
(12) Patent Application Publication
(10) Pub. No.: US 2025/0113398 A1
(43) Pub. Date: Apr. 3, 2025

(54) SYSTEMS AND METHODS FOR ESTABLISHING A MESH NETWORK AMONG CEC-ENABLED SOURCE DEVICES AND CEC-ENABLED SINK DEVICES

(71) Applicant: Netflix, Inc., Los Gatos, CA (US)

(72) Inventors: Akshay Garg, San Jose, CA (US); Michael Aki Schassberger, San Ramon, CA (US)

(21) Appl. No.: 18/735,969

(22) Filed: Jun. 6, 2024

Related U.S. Application Data
(60) Provisional application No. 63/587,533, filed on Oct. 3, 2023.

(51) Int. Cl. H04W 76/14; G09G 5/00; H04N 21/4363; H04W 84/18

(52) U.S. Cl. CPC H04W 76/14; G09G 5/006; H04N 21/43635; G09G 2370/06; G09G 2370/12; H04W 84/18

(57) ABSTRACT

The disclosed computer-implemented methods and systems include establishing a mesh network among CEC-enabled connected devices based on custom, application-specific CEC messaging. For example, the methods and systems described herein operate within a digital content system application to generate and transmit custom CEC messages to other CEC-enabled connected devices. Based on transmitted and received custom CEC messages, the systems and methods described herein establish a mesh network among the CEC-enabled connected devices. Within this mesh network, the systems and methods described herein perform additional tasks such as automatic logins, preventing streaming of media content to devices that have gone into standby mode, and more. Various other methods, systems, and computer-readable media are also disclosed.

### CROSS REFERENCE TO RELATED APPLICATION

This application claims the benefit of U.S. Provisional Application No. 63/587,533, filed 3 Oct. 2023, the disclosure of which is incorporated, in its entirety, by this reference.

### BACKGROUND

Many CEC-enabled devices and systems (e.g., high-definition multimedia interface (HDMI) devices and DisplayPort systems) incorporate consumer electronic control (CEC) features. CEC features enable devices that are physically connected (e.g., via CEC-enabled HDMI or DisplayPort cables) to communicate with and control each other. CEC usage across applications installed on a CEC-enabled device, however, is often dependent on its accurate implementation by that device. Moreover, even if CEC is enabled on a CEC-enabled source device (e.g., a set-top box) and a CEC-enabled sink device (e.g., a TV), its utility is often limited by the CEC features supported by the CEC-enabled source device or the CEC-enabled sink device. As such, CEC messaging can be more fully leveraged by CEC-enabled devices.

### SUMMARY

As will be described in greater detail below, the present disclosure describes embodiments in which a mesh network of CEC-enabled devices is established based on custom, application-specific CEC messages that are opaque to any underlying CEC-inclusive audio/video interfaces.

In one example, a computer-implemented method for establishing a mesh network of CEC-enabled devices includes receiving, by a digital content system application on a CEC-enabled sink device and from a first CEC-enabled source device, a first application-specific message that is opaque to a CEC-inclusive audio/video interface on the CEC-enabled sink device, receiving, by the digital content system application on the CEC-enabled sink device and from a second CEC-enabled source device, a second application-specific message that is opaque to the CEC-inclusive audio/video interface on the CEC-enabled sink device, and establishing a mesh network comprising the CEC-enabled sink device, the first CEC-enabled source device, and the second CEC-enabled source device based on the first application-specific message and the second application-specific message.

In some examples, the first application-specific message and the second application-specific message utilize consumer electronic control features. Additionally, in some examples, the first application-specific message and the second application-specific message are transmitted from instances of the digital content system application on the first CEC-enabled source device and the second CEC-enabled source device.

In some examples, the CEC-inclusive audio/video interface is one of an HDMI interface or a DisplayPort interface. Additionally, in some examples, the method further includes transmitting, from the CEC-enabled sink device, an acknowledgement application-specific message to the first CEC-enabled source device and the second CEC-enabled source device.

In some examples, the acknowledgement application-specific message includes a digital content system ID indicated by the digital content system application on the CEC-enabled sink device. Additionally, in some examples, the method further includes utilizing the mesh network to establish a locality of one or both of the first CEC-enabled source device or the second CEC-enabled source device. Moreover, in some examples, the method further includes utilizing the mesh network to automatically log the first CEC-enabled source device or the second CEC-enabled source device into a digital content system.

Some examples described herein include a system with at least one physical processor and physical memory including computer-executable instructions that, when executed by the at least one physical processor, cause the at least one physical process to perform acts. In at least one example, the computer-executable instructions, when executed by the at least one physical processor, cause the at least one physical process to perform acts including: receiving, by a digital content system application on a CEC-enabled sink device and from a first CEC-enabled source device, a first application-specific message that is opaque to a CEC-inclusive audio/video interface on the CEC-enabled sink device, receiving, by the digital content system application on the CEC-enabled sink device and from a second CEC-enabled source device, a second application-specific message that is opaque to the CEC-inclusive audio/video interface on the CEC-enabled sink device, and establishing a mesh network comprising the CEC-enabled sink device, the first CEC-enabled source device, and the second CEC-enabled source device based on the first application-specific message and the second application-specific message.

In some examples, the above-described method is encoded as computer-readable instructions on a computer-readable medium. In one example, the computer-readable instructions, when executed by at least one processor of a computing device, cause the computing device to: receive, by a digital content system application on a CEC-enabled sink device and from a first CEC-enabled source device, a first application-specific message that is opaque to a CEC-inclusive audio/video interface on the CEC-enabled sink device, receive, by the digital content system application on the CEC-enabled sink device and from a second CEC-enabled source device, a second application-specific message that is opaque to the CEC-inclusive audio/video interface on the CEC-enabled sink device, and establish a mesh network comprising the CEC-enabled sink device, the first CEC-enabled source device, and the second CEC-enabled source device based on the first application-specific message and the second application-specific message.

In one or more examples, features from any of the embodiments described herein are used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an overview diagram of a network environment in which a CEC messaging system operates in accordance with one or more implementations.

FIGS. 2A-2B illustrate the CEC messaging system determining a locality of CEC-enabled devices in accordance with one or more implementations.

FIGS. 3A-3E illustrate the CEC messaging system automatically logging a CEC-enabled device into a digital content system in accordance with one or more implementations.

FIG. 4 is a detailed diagram of the CEC messaging system in accordance with one or more implementations.

Throughout the drawings, identical reference characters and descriptions indicate similar, but not necessarily identical, elements. While the exemplary embodiments described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As mentioned above, CEC messaging has great potential to improve features offered by CEC-enabled devices and DisplayPort systems. For example, one or more implementations described herein feature a CEC messaging system that utilizes CEC messages to establish a mesh network among CEC-enabled devices. In more detail, the CEC messaging system generates custom, application-specific messages on CEC-enabled source and sink devices that are opaque to the underlying CEC-inclusive audio/video interface (e.g., HDMI platforms) on the CEC-enabled source and sink devices. As such, the CEC messaging system utilizes the application-specific messages to associate CEC-enabled devices within a mesh network to service a variety of application-specific use cases.

Features from any of the implementations described herein may be used in combination with one another in accordance with the general principles described herein. These and any other implementations, features, and advantages will be more fully understood upon reading the following detailed description in conjunction with the accompanying drawings and claims.

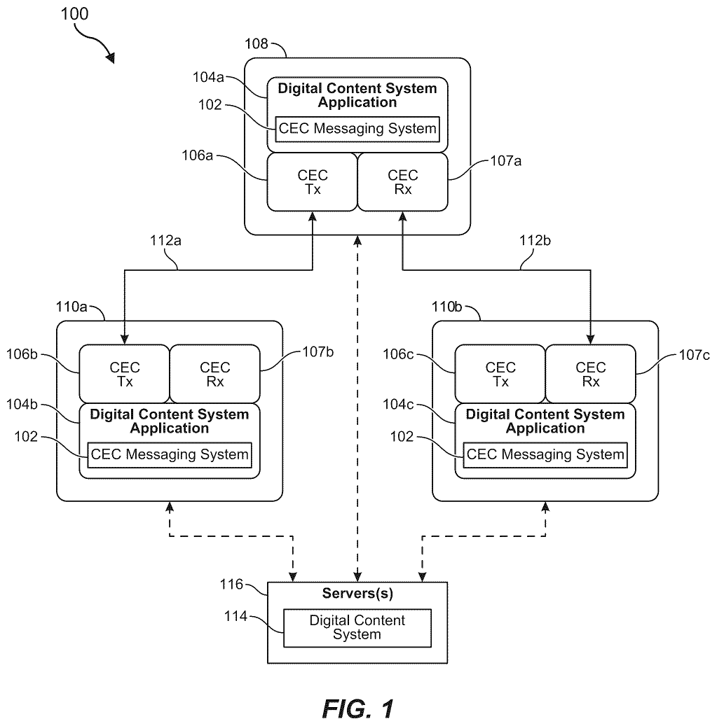

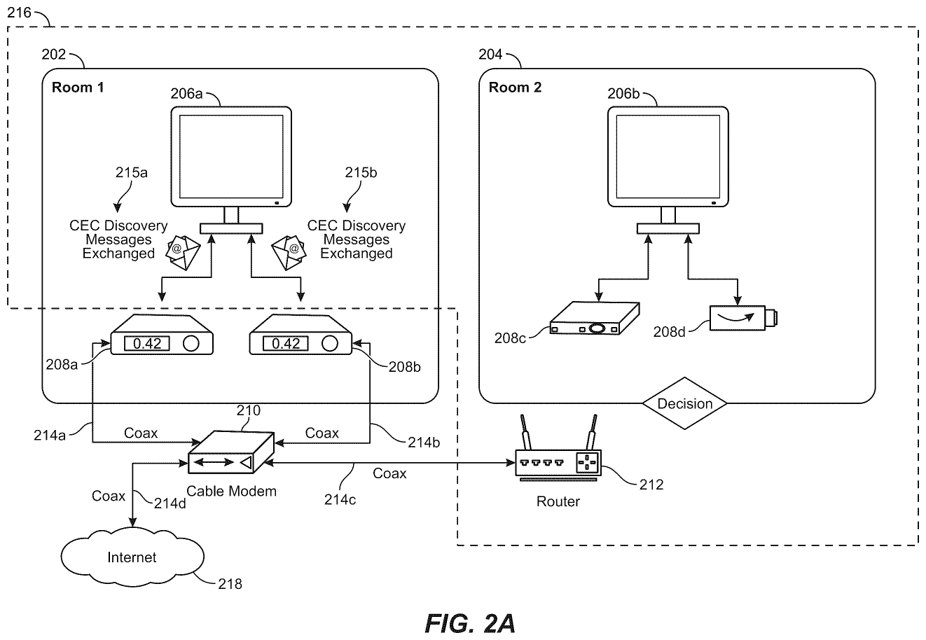

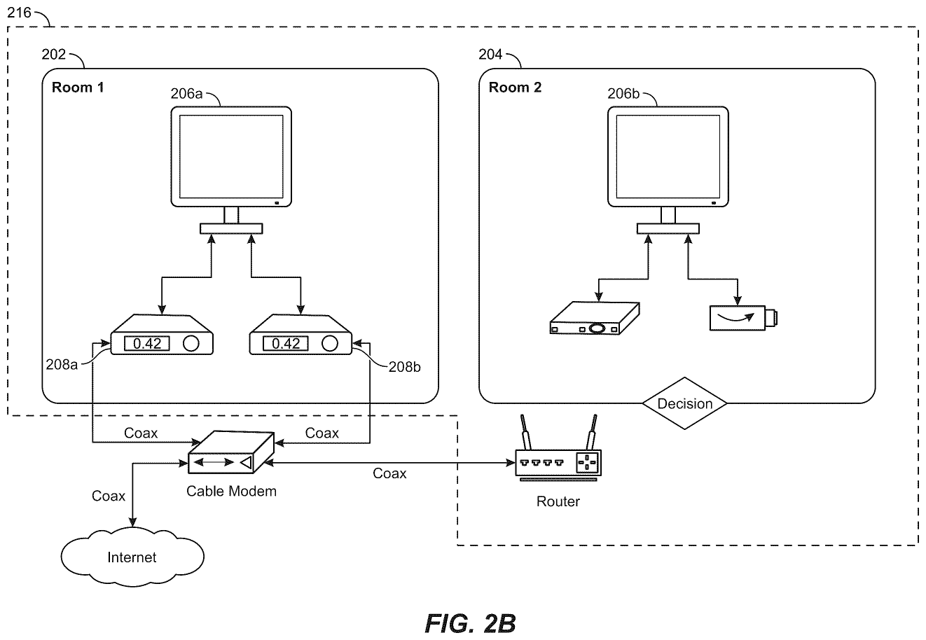

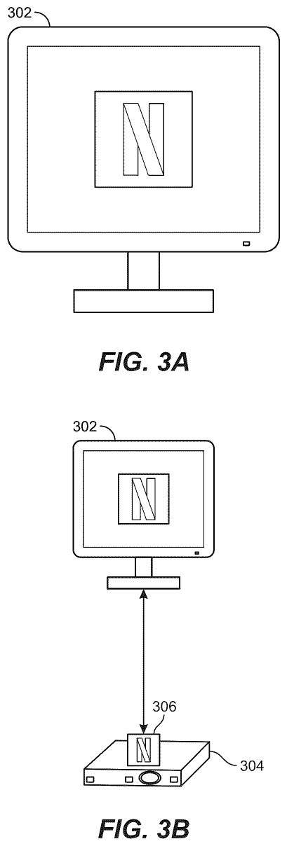

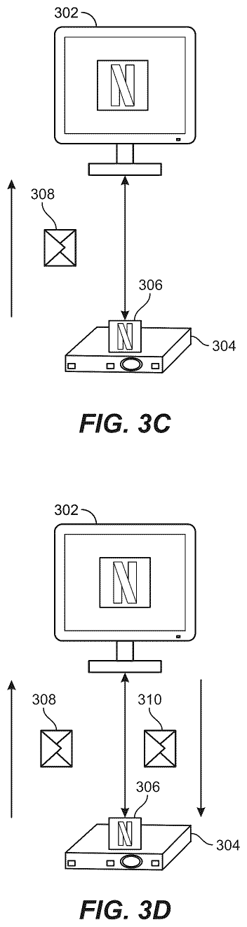

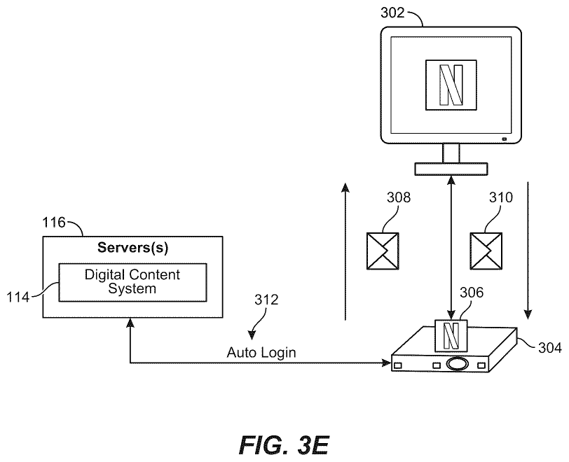

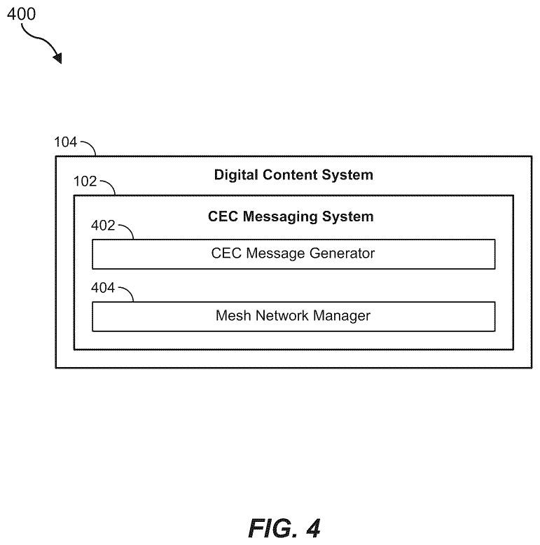

The following will provide, with reference to FIGS. 1-4, detailed descriptions of a CEC messaging system that can establish a mesh communication network among CEC-enabled connected devices based on custom, application-specific CEC messages. For example, an exemplary network environment is illustrated in FIG. 1 to illustrate how the CEC messaging system interacts within CEC-enabled connected source and sink devices. FIGS. 2A-2B illustrate the CEC messaging system utilizing custom CEC messages to determine a locality of one or more CEC-enabled devices. FIGS. 3A-3E illustrate the CEC messaging system automatically logging a CEC-enabled device into a digital content system. Finally, FIG. 4 illustrates additional detail associated with the CEC messaging system.

As used herein, the term “CEC-enabled device” refers to an electronic device that is capable of bi-directional communication according to the CEC standard. In most examples, a CEC-enabled device is also controllable by CEC communications received from other CEC-enabled devices via one or more physical connections (e.g., HDMI connections, DisplayPort connections). To illustrate, in one example, a television remote control is capable of controlling the television and any other CEC-enabled devices connected via HDMI to the television (e.g., a set-top box and a DVD player).

As used herein, a “CEC-enabled source device” is a CEC-enabled device that transmits information, data, commands, etc. to other CEC-enabled devices. Additionally, as used herein a “CEC-enabled sink device” is a CEC-enabled device that receives information, data, commands, etc. In most examples discussed herein, a CEC-enabled source device is a streaming device (e.g., a set-top box, a streaming dongle) that receives digital content from a digital content system and transmits (e.g., via HDMI or DisplayPort) that digital content to a CEC-enabled sink device for display. As such, in most examples, a CEC-enabled sink device is a display device such as a smart TV.

As used herein, “CEC-inclusive audio/video interface” refers to an interface on a CEC-enabled device that supports and manages CEC communications. In most examples, a CEC-inclusive audio/video interface includes an HDMI interface or DisplayPort interface that manages CEC communications according to platform-specific protocols.

As just mentioned, FIG. 1 illustrates an exemplary networking environment 100 implementing aspects of the present disclosure. In the illustrated example, the exemplary networking environment 100 includes a CEC-enabled sink device 108, a first CEC-enabled source device 110a, and a second CEC-enabled source device 110b. In some examples, the CEC-enabled sink device 108 is a display device such as a television, while the first CEC-enabled source device 110a and the second CEC-enabled source device 110b are set top boxes or other CEC-enabled broadcasting devices.

As further shown in FIG. 1, the CEC-enabled sink device 108, the first CEC-enabled source device 110a, and the second CEC-enabled source device 110b include instances of a digital content system application 104a, 104b, and 104c. In one or more implementations, the digital content system applications 104a-104c receive streamed digital content from a digital content system 114 on a server(s) 116. In some examples, the digital content system applications 104a-104c also transmit usage and other information to the digital content system 114. In many examples, the digital content system 114 is connected to the digital content system applications 104a-104c over a communication network, such as the Internet, and includes one or more physical connections, such as a LAN, and/or wireless connections, such as a WAN.

As additionally illustrated in FIG. 1, each of the CEC-enabled sink device 108, the first CEC-enabled source device 110a, and the second CEC-enabled source device 110b include CEC messaging functionality. For example, the CEC-enabled sink device 108, the first CEC-enabled source device 110a, and the second CEC-enabled source device 110b include CEC transmission modules 106a, 106b, and 106c, as well as CEC receiving modules 107a, 107b, and 107c, respectively. In many examples, the CEC-enabled sink device 108, the first CEC-enabled source device 110a, and the second CEC-enabled source device 110b communicate via the CEC transmission modules 106a-106c and the CEC receiving modules 107a-107c across CEC-enabled connections 112a and 112b. In one or more implementations, the CEC-enabled connections 112a-112b are physical connections (e.g., CEC-enabled cables, etc.). In most examples, the CEC-enabled connections 112a-112b create logical connections between the CEC-enabled devices included in the exemplary networking environment. For example, once the first CEC-enabled source device 110a and the second CEC-enabled source device 110b are connected to the CEC-enabled sink device 108 by the physical CEC-enabled connections 112a, 112b, the CEC messaging system 102 creates logical connection between the first CEC-enabled source device 110a and the second CEC-enabled source device 110b.

In one or more implementations, the digital content system applications 104a-104c include a CEC messaging system 102. In most examples, the CEC messaging system 102 generates and transmits custom CEC messages that are opaque to CEC platforms supporting the CEC transmission modules 106a-106c and the CEC receiving modules 107a-107c. Utilizing these custom CEC messages, the CEC messaging system 102 establishes a mesh network including the CEC-enabled sink device 108, the first CEC-enabled source device 110a, and the second CEC-enabled source device 110b.

In one or more examples, and once the mesh network is established, the CEC messaging system 102 further performs additional utilities utilizing the mesh network. For example, and as will be discussed in greater detail below, the CEC messaging system 102 utilizes the mesh network to establish a locality of one or both of the first CEC-enabled source device 110a or the second CEC-enabled source device 110b. Additionally, in some examples, the CEC messaging system 102 utilizes the mesh network to automatically log the first CEC-enabled source device 110a or the second CEC-enabled source device 110b into the digital content system application 104b or digital content system application 104c, respectively.

Although FIG. 1 shows the exemplary networking environment 100 with one CEC-enabled sink device and two CEC-enabled source devices, other arrangements are possible. For example, in additional implementations, the exemplary networking environment 100 can include any number of CEC-enabled sink devices and/or CEC-enabled source devices. Moreover, in some implementations, the exemplary networking environment 100 exists in the same locality (e.g., the same household). In other implementations, the exemplary networking environment 100 exists across more than one locality. Additionally, while FIG. 1 illustrates the exemplary networking environment 100 including CEC-enabled devices, the CEC messaging system 102 offers the same functionality in connection with other systems such as DisplayPort systems.

As mentioned above, the CEC messaging system 102 generates and transmits application-specific CEC messages among CEC-enabled source and sink devices to establish a mesh network. Within this mesh network, the CEC-enabled device can exchange application-specific information for use in various application-specific use cases that are beyond typical CEC messaging utilization. FIGS. 2A-2B and 3A-3E illustrate some of these application-specific use cases.

For example, FIGS. 2A-2B illustrate how the CEC messaging system 102 utilizes CEC custom messaging to establish localities of CEC-enabled devices. In more detail, as shown in the example illustrated in FIG. 2A, a first room 202 includes a CEC-enabled sink device 206a (e.g., a TV, a smart monitor) that has CEC-enabled connections to CEC-enabled source devices 208a and 208b (e.g., cable set-top boxes). The CEC-enabled source devices 208a, 208b are further connected via coaxial cables 214a and 214b to a cable modem 210. Additionally, a second room 204 includes a CEC-enabled sink device 206b (e.g., a TV) that has CEC-enabled connections to CEC-enabled source devices 208c and 208d (e.g., wireless streaming devices). In at least one implementation, the CEC-enabled source devices 208c and 208d are wirelessly connected to a WiFi router 212 that is physically connected via a coaxial cable 214c to the cable modem 210. The cable modem 210 is further physically connected to the internet 218 via a coaxial cable 214d.

While FIGS. 2A-2B illustrate one arrangement of devices, other arrangements are possible. For example, in some implementations, the cable modem 210 and the WiFi router 212 are connected via Ethernet, rather than by the coaxial cable 214c. In some implementations, the cable modem 210 and the WiFi router 212 are combined into an all-in-one unit. In some implementations, for example, the cable modem 210 is connected to the internet 218 via fiber optic cable, rather than by the coaxial cable 214c.

In this arrangement, for example, the CEC-enabled sink device 206a, the CEC-enabled sink device 206b, the CEC-enabled source devices 208c, 208d, and the WiFi router 212 are on a first subnet. The CEC-enabled source device 208a and the CEC-enabled source device 208b, however, are on a different second subnet. This may be because the CEC-enabled source devices 208a, 208b are special set-top boxes provided by an Internet service provider for ensuring that the user can watch high-definition content on the CEC-enabled sink device 206a. Thus, due to the different subnets in use, applications installed on any of the CEC-enabled devices (e.g., the CEC-enabled sink devices 206a, 206b or the CEC-enabled source devices 208a-208d) experience difficulties in determining a locality of each CEC-enabled device across the separate subnets. For example, the CEC-enabled sink devices 206a, 206b and the CEC-enabled source devices 208c-208d may be able to discover each other and determine that they are all in the same locality 216. In some implementations, the CEC-enabled source device 208a, 208b are each on subnets that are separate from each other and from the other subnet that includes the CEC-enabled sink devices 206a, 206b and the CEC-enabled source devices 208c, 208d. As such, all of the CEC-enabled devices shown in FIG. 2A would not be able to correctly determine that they are all in the same locality.

The CEC messaging system 102, however, can ensure accurate locality determinations within scenarios such as the one illustrated in FIG. 2A. For example, as further shown in FIG. 2A, the CEC messaging system 102 is installed as part of the digital content system application (e.g., the digital content system applications 104a-104c illustrated in FIG. 1) on the CEC-enabled sink devices 206a-206b and CEC-enabled source devices 208a-208d. In one or more examples, the CEC messaging system 102 generates and exchanges CEC discovery messages 215a and 215b (e.g., application-specific messages) between the CEC-enabled sink device 206a and the CEC-enabled source devices 208a, 208b. Based on the CEC discovery messages 215a, 215b, the CEC messaging system 102 determines that the locality 216 includes the CEC-enabled source devices 208a, 208b, in addition to all of the other CEC-enabled devices, as shown in FIG. 2B. In some examples, the CEC discovery messages 215a, 215b include a single message exchanged between the CEC-enabled source devices 208a-208b and the CEC-enabled sink device 206a. In additional examples, the CEC discovery messages 215a, 215b include any number of messages exchanged according to a predetermined protocol.

In one or more implementations, the CEC discovery messages 215a, 215b include information that is specific to the digital content system application installed on each CEC-enabled device. In some examples, the CEC messaging system 102 on the CEC-enabled source device 208a generates a CEC discovery message that includes a location and/or device identifier. The CEC messaging system 102 on the CEC-enabled sink device 206a checks the received location identifier against a locally stored location identifier. If the identifiers match, the CEC messaging system 102 on the CEC-enabled sink device 206a determines that the CEC-enabled source device 208a is in the same locality 216 as the CEC-enabled sink device 206a. As mentioned above, the CEC discovery messages 215a, 215b are opaque (e.g., meaningless) to the CEC-inclusive audio/video interfaces operating on the CEC-enabled sink device 206a, the CEC-enabled source device 208a, and the CEC-enabled source device 208b. In some implementations, information within the CEC discovery messages 215a, 215b (e.g., a location identifier) is further encrypted with keys that are stored by the digital content system 114.

Another application-specific use case is illustrated in FIGS. 3A-3E. In this example, the CEC messaging system 102 utilizes custom CEC messaging to automatically log a CEC-enabled source device into the digital content system 114. For example, as shown in FIG. 3A, a CEC-enabled sink device 302 (e.g., a smart TV) is logged into the digital content system 114 via a digital content system application installed thereon.

As further shown in FIG. 3B, a user connects the CEC-enabled sink device 302 to a new CEC-enabled source device 304 (e.g., a set-top box). In one or more examples, the new CEC-enabled source device 304 includes or is installed with an instance of the digital content system application 306. In most examples, the digital content system application 306 requires that the user enter login information such that the digital content system application 306 can operate under the user's account within the digital content system 114. Often, entering login information can be a clumsy and painstaking process where the user selects individual letters and numbers with a TV remote.

In the example illustrated in FIGS. 3A-3E, however, the CEC messaging system 102 utilizes custom CEC messages to automatically log the CEC-enabled source device 304 into the digital content system 114. For example, as shown in FIG. 3C, once the digital content system application 306 is installed on the new CEC-enabled source device 304, the CEC messaging system 102 within the digital content system application 306 generates and transmits a custom CEC message 308. In one or more implementations, the custom CEC message 308 is directed to the digital content system application installed on the CEC-enabled sink device 302. In additional implementations, the custom CEC message 308 is a broadcast message to all devices within the same CEC-enabled topology. In that implementation, for example, the CEC messaging system 102 within the digital content system application 306 transmits the custom CEC message 308 to any CEC-enabled device within the same topology that is also running an instance of the digital content system application 306. In one or more implementations, the custom CEC message 308 includes a request for login information, a device identifier for the CEC-enabled sink device 302, a locality identifier, etc.

In one example, and in response to receiving the custom CEC message 308 from the CEC-enabled source device 304, the digital content system application on the CEC-enabled sink device 302 generates and transmits a response CEC message 310, as shown in FIG. 3D. In one or more implementations, the response CEC message 310 includes the requested device identifier for the CEC-enabled sink device 302. In at least one implementation, the contents of the CEC message 310 are encrypted such that any information therein is protected.

After receiving the response CEC message 310 from the digital content system application on the CEC-enabled sink device 302, the digital content system application 306 on the CEC-enabled source device 304 utilizes the device identifier for the CEC-enabled sink device 302 from the response CEC message 310 to generate a login request for the digital content system 114. For example, as shown in FIG. 3E, the digital content system application 306 on the CEC-enabled source device 304 generates an automatic login request 312 that requests the digital content system 114 to log the digital content system application 306 into the same account into which the digital content system application on the CEC-enabled sink device 302 (i.e., indicated by its device identifier) is logged. The digital content system application 306 then transmits the automatic login request 312 to the digital content system 114 on the server(s) 116. Once the automatic login request 312 is received, the digital content system 114 logs in the digital content system application 306 on the CEC-enabled source device 304 such that the digital content system application 306 can access information and content associated with the user's account within the server(s) 116.

In additional examples, the digital content system application 306 generates and transmits a custom CEC message 308 to the digital content system application installed on the CEC-enabled sink device 302 that requests additional login information from the digital content system application 306 on the CEC-enabled sink device 302 beyond the device identifier. To illustrate, in one example, the digital content system application 306 generates the custom CEC message 308 requesting a locality identifier, a digital content system ID associated with a user account, specific login usernames or passwords, or an authorized login command for the digital content system 114 that is associated with the user's account within the digital content system 114. Once the digital content system application 306 receives the requested information, the digital content system application 306 utilizes this information to directly log into the digital content system 114, rather than sending the automatic login request 312.

As discussed above, the CEC messaging system 102 performs various functions in connection with establishing a mesh network among CEC-enabled source and sink devices. FIG. 4 is a block diagram 400 of the CEC messaging system 102. As mentioned above, the CEC messaging system 102 can operate as part of the digital content system application (e.g., the digital content system application 104a-104c) on both CEC-enabled source devices and CEC-enabled sink devices while performing these functions. As such, FIG. 4 provides additional detail with regard to these functions. For example, as shown in FIG. 4, the CEC messaging system 102 includes a CEC message generator 402 and a mesh network manager 404.

In certain implementations, the CEC messaging system 102 may represent one or more software applications or programs that, when executed by a computing device, may cause the computing device to perform one or more tasks. For example, and as will be described in greater detail below, one or more of the CEC message generator 402 or the mesh network manager 404 may represent software stored and configured to run on one or more computing devices, such as the CEC-enabled devices described herein. One or more of the CEC message generator 402 and the mesh network manager 404 of the CEC messaging system 102 shown in FIG. 4 may also represent all or portions of one or more special purpose computers to perform one or more tasks.

As just mentioned, and as shown in FIG. 4, the CEC messaging system 102 includes the CEC message generator 402. In one or more implementations, the CEC message generator 402 identifies certain triggers. For example, the CEC message generator 402 can identify a trigger in response to initialization of a new instance of the digital content system application 104 (e.g., prior to login). In another example, the CEC message generator 402 can identify a trigger in response to receiving a custom CEC message that is specific to the digital content system application 104 such as a discovery request from another CEC-enabled device.

In one or more implementations, the CEC message generator 402 further generates custom CEC messages based on the identified triggers. For example, in response to determining that a new instance of the digital content system application 104 has been initialized but has not successfully logged in to the digital content system 114, the CEC message generator 402 generates a custom CEC message for transmission to any other CEC-enabled devices that are connected via CEC-enabled connections to the CEC-enabled device on which the digital content system application 104 is installed. As discussed above, the CEC message generator 402 generates the custom CEC message requesting login information from any other digital content system application that is already logged in to a user account on the digital content system 114. In some implementations, the CEC message generator 402 generates acknowledgement CEC messages in response to receiving custom CEC messages from another device within a mesh network.

In other examples, the CEC message generator 402 generates custom CEC messages that include locality and/or device identifiers in response to discovery requests, such as discussed above in connection with FIGS. 2A and 2B. In yet other examples, the CEC message generator 402 generates custom CEC messages including a digital content system ID associated with a specific user account on the digital content system 114. Additionally, the CEC message generator 402 generates custom CEC messages that include information indicating capabilities of the CEC-enabled device where the digital content system application 104 is installed.

Moreover, in some examples, the CEC message generator 402 generates custom CEC messages that communicate a CEC-enabled device's standby state and/or active state. To illustrate, if the digital content system application 104 is installed on a smart TV, the CEC message generator 402 can detect when the smart TV is active or is going into standby mode (e.g., in response to receiving a message indicating as much from the smart TV). The CEC message generator 402 then generates and transmits a custom CEC message communicating this state to another CEC-enabled source device such as a set-top box. If the TV is going into a standby mode, the CEC-enabled source device can pause a content stream that was directed to the smart TV. All of this can happen without any user-facing implications.

As discussed above, the CEC message generator 402 generates the custom CEC messages to be opaque to any CEC-inclusive audio/video interface or platform running on a device where the digital content system application 104 is installed. For example, the CEC message generator 402 generates the CEC messages including digital content system application-specific commands, terms, data, and so forth. Moreover, in some examples, the CEC message generator 402 further encrypts the information contained with the custom CEC messages that are generated.

As further mentioned above, and as shown in FIG. 4, the CEC messaging system 102 includes the mesh network manager 404. In one or more implementations, the mesh network manager 404 establishes a mesh network based on the custom CEC messages received from other CEC-enabled devices. For example, as discussed above, the mesh network manager 404 establishes a mesh network among CEC-enabled devices in response to receiving custom CEC messages from the CEC-enabled devices indicating they are all within the same locality.

Once a mesh network is established, the mesh network manager 404 performs tasks within the mesh network. For example, as discussed above, the mesh network manager 404 automatically logs new CEC-enabled devices into the digital content system 114. Moreover, as further discussed above, the mesh network manager 404 determines device locations based on an established mesh network. Additionally, the mesh network manager 404 determines that the digital content system application 104 is streaming digital content to a CEC-enabled display device that is in standby mode and instructs the digital content system application 104 to pause the digital content stream.

In one or more implementations, the CEC-enabled device on which the digital content system application 104 is installed includes one or more physical processors. The one or more physical processors are generally any type or form of hardware-implemented processing unit capable of interpreting and/or executing computer-readable instructions. In one implementation, the physical processors access and/or modify one or more of the components of the CEC messaging system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, in one or more implementations, the CEC-enabled devices on which the digital content system application 104 is installed include a memory. In at least one implementation, the memory generally represents any type or form of volatile or non-volatile storage device or medium capable of storing data and/or computer-readable instructions. In one example, the memory stores, loads, and/or maintains one or more of the components of the CEC messaging system 102. Examples of the memory include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

In summary, the CEC messaging system 102 leverages the functionality of CEC messaging to establish a mesh network among CEC-enabled connected devices. For example, the CEC messaging system 102 operates within digital content system applications installed on the CEC-enabled devices. The CEC messaging system 102 further generates and transmits CEC messages among the CEC-enabled connected devices that are specific to the digital content system applications thereon. As such, the CEC messaging system 102 utilizes CEC messaging to communicate information among the CEC-enabled connected devices that are opaque (e.g., unreadable) to the underlying CEC-inclusive audio/video interfaces or platforms. Once this mesh communication network is established between the CEC-enabled devices, the CEC messaging system 102 can perform various tasks such as locality detection, automatic logins, standby streaming reduction, and more.

### EXAMPLE EMBODIMENTS

Example 1: A computer-implemented method for establishing a mesh network of CEC-enabled devices. For example, the method may include receiving, by a digital content system application on a CEC-enabled sink device and from a first CEC-enabled source device, a first application-specific message that is opaque to a CEC-inclusive audio/video interface on the CEC-enabled sink device, receiving, by the digital content system application on the CEC-enabled sink device and from a second CEC-enabled source device, a second application-specific message that is opaque to the CEC-inclusive audio/video interface on the CEC-enabled sink device, and establishing a mesh network comprising the CEC-enabled sink device, the first CEC-enabled source device, and the second CEC-enabled source device based on the first application-specific message and the second application-specific message.

Example 2: The computer-implemented method of Example 1, wherein the first application-specific message and the second application-specific message utilize consumer electronic control features.

Example 3: The computer-implemented method of any of Examples 1 and 2, wherein the first application-specific message and the second application-specific message are transmitted from instances of the digital content system application on the first CEC-enabled source device and the second CEC-enabled source device.

Example 4: The computer-implemented method of any of Examples 1-3, wherein the CEC-inclusive audio/video interface is one of an HDMI interface or a DisplayPort interface.

Example 5: The computer-implemented method of any of Examples 1-4, further including transmitting, from the CEC-enabled sink device, an acknowledgement application-specific message to the first CEC-enabled source device and the second CEC-enabled source device.

Example 6: The computer-implemented method of any of Examples 1-5, wherein the acknowledgement application-specific message includes a digital content system ID indicated by the digital content system application on the CEC-enabled sink device.

Example 7: The computer-implemented method of any of Examples 1-6, further including utilizing the mesh network to establish a locality of one or both of the first CEC-enabled source device or the second CEC-enabled source device.

Example 8: The computer-implemented method of any of Examples 1-7, further including utilizing the mesh network to automatically log the first CEC-enabled source device or the second CEC-enabled source device into a digital content system.

In some examples, a system may include at least one processor and a physical memory including computer-executable instructions that, when executed by the at least one processor, cause the at least one processor to perform various acts. For example, the computer-executable instructions may cause the at least one processor to perform acts including receiving, by a digital content system application on a CEC-enabled sink device and from a first CEC-enabled source device, a first application-specific message that is opaque to a CEC-inclusive audio/video interface on the CEC-enabled sink device, receiving, by the digital content system application on the CEC-enabled sink device and from a second CEC-enabled source device, a second application-specific message that is opaque to the CEC-inclusive audio/video interface on the CEC-enabled sink device, and establishing a mesh network comprising the CEC-enabled sink device, the first CEC-enabled source device, and the second CEC-enabled source device based on the first application-specific message and the second application-specific message.

Additionally in some examples, a non-transitory computer-readable medium can include one or more computer-executable instructions that, when executed by at least one processor of a computing device, cause the computing device to perform various acts. For example, the one or more computer-executable instructions may cause the computing device to receive, by a digital content system application on a CEC-enabled sink device and from a first CEC-enabled source device, a first application-specific message that is opaque to a CEC-inclusive audio/video interface on the CEC-enabled sink device, receive, by the digital content system application on the CEC-enabled sink device and from a second CEC-enabled source device, a second application-specific message that is opaque to the CEC-inclusive audio/video interface on the CEC-enabled sink device, and establish a mesh network comprising the CEC-enabled sink device, the first CEC-enabled source device, and the second CEC-enabled source device based on the first application-specific message and the second application-specific message.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a digital content system application on a CEC-enabled sink device and from a first CEC-enabled source device, a first application-specific message that is opaque to a CEC-inclusive audio/video interface on the CEC-enabled sink device;
receiving, by the digital content system application on the CEC-enabled sink device and from a second CEC-enabled source device, a second application-specific message that is opaque to the CEC-inclusive audio/video interface on the CEC-enabled sink device; and
establishing a mesh network comprising the CEC-enabled sink device, the first CEC-enabled source device, and the second CEC-enabled source device based on the first application-specific message and the second application-specific message.

2. The computer-implemented method of claim 1, wherein the first application-specific message and the second application-specific message utilize consumer electronic control features.

3. The computer-implemented method of claim 1, wherein the first application-specific message and the second application-specific message are transmitted from instances of the digital content system application on the first CEC-enabled source device and the second CEC-enabled source device.

4. The computer-implemented method of claim 1, wherein the CEC-inclusive audio/video interface is one of an HDMI interface or a DisplayPort interface.

5. The computer-implemented method of claim 4, further comprising transmitting, from the CEC-enabled sink device, an acknowledgement application-specific message to the first CEC-enabled source device and the second CEC-enabled source device.

6. The computer-implemented method of claim 5, wherein the acknowledgement application-specific message comprises a digital content system ID indicated by the digital content system application on the CEC-enabled sink device.

7. The computer-implemented method of claim 1, further comprising utilizing the mesh network to establish a locality of one or both of the first CEC-enabled source device or the second CEC-enabled source device.

8. The computer-implemented method of claim 1, further comprising utilizing the mesh network to automatically log the first CEC-enabled source device or the second CEC-enabled source device into a digital content system.

9. A system comprising:
at least one physical processor; and
physical memory comprising computer-executable instructions that, when executed by the at least one physical processor, cause the at least one physical processor to perform acts comprising:
receiving, by a digital content system application on a CEC-enabled sink device and from a first CEC-enabled source device, a first application-specific message that is opaque to a CEC-inclusive audio/video interface on the CEC-enabled sink device;
receiving, by the digital content system application on the CEC-enabled sink device and from a second CEC-enabled source device, a second application-specific message that is opaque to the CEC-inclusive audio/video interface on the CEC-enabled sink device; and
establishing a mesh network comprising the CEC-enabled sink device, the first CEC-enabled source device, and the second CEC-enabled source device based on the first application-specific message and the second application-specific message.

10. The system of claim 9, wherein the first application-specific message and the second application-specific message utilize consumer electronic control features.

11. The system of claim 9, wherein the first application-specific message and the second application-specific message are transmitted from instances of the digital content system application on the first CEC-enabled source device and the second CEC-enabled source device.

12. The system of claim 9, wherein the CEC-inclusive audio/video interface is one of an HDMI interface or a DisplayPort interface.

13. The system of claim 12, further comprising transmitting, from the CEC-enabled sink device, an acknowledgement application-specific message to the first CEC-enabled source device and the second CEC-enabled source device.

14. The system of claim 13, wherein the acknowledgement application-specific message comprises a digital content system ID indicated by the digital content system application on the CEC-enabled sink device.

15. The system of claim 9, further comprising utilizing the mesh network to establish a locality of one or both of the first CEC-enabled source device or the second CEC-enabled source device.

16. The system of claim 9, further comprising utilizing the mesh network to automatically log the first CEC-enabled source device or the second CEC-enabled source device into a digital content system.

17. A non-transitory computer-readable medium comprising one or more computer-executable instructions that, when executed by at least one processor of a CEC-enabled sink device, cause the CEC-enabled sink device to:
receive, by a digital content system application on the CEC-enabled sink device and from a first CEC-enabled source device, a first application-specific message that is opaque to a CEC-inclusive audio/video interface on the CEC-enabled sink device;
receive, by the digital content system application on the CEC-enabled sink device and from a second CEC-enabled source device, a second application-specific message that is opaque to the CEC-inclusive audio/video interface on the CEC-enabled sink device; and
establish a mesh network comprising the CEC-enabled sink device, the first CEC-enabled source device, and the second CEC-enabled source device based on the first application-specific message and the second application-specific message.

18. The non-transitory computer-readable medium of claim 17, wherein the first application-specific message and the second application-specific message utilize consumer electronic control features.

19. The non-transitory computer-readable medium of claim 17, wherein the first application-specific message and the second application-specific message are transmitted from instances of the digital content system application on the first CEC-enabled source device and the second CEC-enabled source device.

20. The non-transitory computer-readable medium of claim 17, further comprising one or more computer-executable instructions that, when executed by the at least one processor of the CEC-enabled sink device, cause the CEC-enabled sink device to log the digital content system application on the CEC-enabled sink device into a digital content system.
